(19) United States
(12) Patent Application Publication
(10) Pub. No.: US 2002/0152038 A1
(43) Pub. Date: Oct. 17, 2002

(54) Selection method for aroma substances

(76) Inventors: Steffen Sonnenberg, Holzminden (DE); Anja Finke, Holzminden (DE); Andreas Klamt, Leverkusen (DE); John Lohrenz, Leverkusen (DE); Thorsten Burger, Koln (DE); Svend Matthiesen, Leverkusen (DE)

Correspondence Address: BAYER CORPORATION, PATENT DEPARTMENT, 100 BAYER ROAD, PITTSBURGH, PA, 15205, US

(21) Appl. No.: 10/029,544

(22) Filed: Dec. 20, 2001

(30) Foreign Application Priority Data
Dec. 27, 2000 (DE) 10065444.4

(51) Int. Cl. G06F 19/00

(52) U.S. Cl. 702/25

(57) ABSTRACT

A mathematical determination model is used to select aroma substances for products to be aromatized and for the preparation.

### FIELD OF THE INVENTION

The invention relates to a selection method for aroma substances for use in aromatized products, in which mathematical determination models are used. The present invention also relates to products to which aroma substances have been added in which the aroma substances are selected using the mathematical determination models. The present invention further relates to a selection method for the synthesis of novel aroma substances in which mathematical determination models are used. The present invention further relates to aroma substances for which mathematical determination models are used for selection for the preparation of aroma substances. The present invention further relates to products to which aroma substances have been added in which mathematical determination models are used for the selection for the preparation of the aroma substances.

### BACKGROUND OF THE INVENTION

Aroma substances are used to improve odor and taste in a large number of products (aromatized foods and packaging). As a result of the aromatizing of foods, the impression of, for example, the fullness, ripeness and naturalness of the taste and odor can be significantly enhanced. Moreover, the loss of aroma substances due to techniques used in the production can be compensated for. The use of aroma substances, therefore, represents a product improvement.

Throughout all of the application steps of the various aromatized foods, i.e. before, during and after application, some of the aroma substances are lost and cannot be perceived by smell and/or taste by the user. For example, thermolabile aroma substances are destroyed when the food is heated. Furthermore, it is known that the release of aroma substances when foods are consumed depends, because of numerous chemical and physical interactions, very much on the ingredients such as water, fats and carbohydrates (A. Taylor, Flavor matrix interaction, p. 123-138, in K. A. D. Swift, Current topics in flavours and fragrances). This can lead to individual aroma substances being retained by the food to an extent such that they can no longer be detected by smell and taste.

To solve this problem, flavorists have selected, based on their experience and following laborious sensory tests, the aroma substances which have a high taste intensity before, during and after the preparation operation or during consumption in the product to be aromatized in each case. In the case of these aroma substances, the loss during the preparation operation is reduced and the taste intensity increases. This procedure is very laborious and is unable to give a comprehensive overview with regard to the suitability of all relevant aroma substances in all application steps of the product.

The perception of a volatile aromatization from foods first takes place via the nose (orthonasally) and then retronasally after the food has been placed in the oral cavity (K. Plattig, Sensory analysis of foods, p. 1-23; Meilgaard, Civille, Carr, Sensory evaluation Techniques, p. 7-22). Here, it is clear that an aromatization must consist of aroma substances with a sufficient concentration in the headspace above the aromatized product and must not remain permanently in the aromatized food.

Consequently, a partition parameter can be defined as the distribution of the aroma substance between, on the one hand, the solid or liquid phase in the food or its use form, such as, for example, an aqueous solution, and, on the other hand, the gas phase surrounding the food: the higher the concentration of an aroma substance in the gas phase relative to the concentration of the aroma substance in the solid or liquid phase of the food, the higher the numerical values of the partition parameter. This distribution depends individually on the ingredients of the food and the application step in question, and on the specific molecular properties of the aroma substances.

As is known, to determine the olfactory quality and suitability of aroma substances based on foods, such as, for example, fat-containing emulsions, and also during and after use of the foods, gas chromatography olfactometry is used. This determines the aroma substances suitable for the aromatization. This performance-related work includes both analytical and also sensory measurements, and the information is then used in the preparation of aromatizations (N. Fischer, T. van Eijk, ACS Symposium Series 633, 1996, p. 164-178).

It is also known that different foods influence the release of aroma substances to markedly varying degrees. It is noteworthy that even different formulations of a food category, e.g. different fat-containing emulsions, differ in terms of the distribution behavior of the aroma substances such that the sensory properties of the products differ markedly from one another (P. de Kok, H. Smorenburg, Flavor Chemistry, 1999, Flavor release in the mouth, p. 397-407). For this reason, determination of the partition parameters should expediently be carried out for each individual food when the aroma is reformulated. In the daily practice of creating aromas, this work cannot be carried out due to the enormous cost.

M. Harrison and B. Hills describe a mathematical model for the release of aroma substances from liquids with aroma substance-binding macromolecules. This model describes the distribution of the two aroma substances diacetyl and 2-heptanone by means of chemical kinetics of the first order and experimental transfer rates between a liquid and gaseous phase (M. Harrison, B. Hills, J. Agric. Food Chem. 1997, 45, p. 1883-1890).

D. Roberts and T. Acree (D. Roberts, T. Acree; Model development for flavour release from homogenous phases, in Flavour Science, 1996, p. 399-404) describe the development of a predictive model for the release of aroma substances from a homogeneous phase by means of an oil-water-air distribution theory and empirical relationships between viscosity and temperature (equation (3) in D. Roberts, T. Acree; p. 401). Using the example of a homogeneous model mixture of water and soya bean oil, the forecasting power of this method for a few aroma substances is given as r²=0.9. However, to use this model, costly experimental partitioning coefficients for aroma substances and experimental viscosity values are required, which are not generally available (D. Roberts, T. Acree; Model development for flavour release from homogenous phases, in Flavour Science, 1996, p. 404). Accordingly, this method is not a purely predictive method, but uses experimental partition coefficients of the aroma substances between air-water, air-oil and oil-water as descriptors and the viscosity of the model mixture.

Furthermore, D. Roberts and T. Acree describe the predictive power of known descriptors such as the octanol-water partition coefficient (logP), the vapor pressure and the boiling point (b.p.) as inadequate.

The prediction of the release of aroma substances by means of a non-equilibrium partition model is described by K. Roos and K. Wolswinkel (K. Roos, K. Wolswinkel, Trends in Flavour Research, 1994, Non-equilibrium partition model for predicting flavour release in the mouth, p. 15-32). In the physicochemical model, simulation of the chewing process is carried out. Here, the release of aroma substances from chewing-gum is explained as a consequence of the composition of the food and on the basis of the mass transfer resistance. This model is used to calculate the dynamic behavior of an aroma substance based on known physicochemical properties. The prediction model is used when an aroma is reformulated.

In a QSAR (Böhm, Klebe, Kubinyi, Wirkstoffdesign [Active Ingredient Design], p. 363), a correlation between experimental values, such as, for example, the active concentration of active ingredients, on the one hand and physicochemical values on the other hand is carried out. These physicochemical values, so-called descriptors, describe the chemical structure of the active ingredient.

Within the fragrance and flavor industry sector, the QSAR approach is used for explaining odor and taste properties and for developing novel fragrances and aroma substances (Angew. Chem. 2000, 112, 3106-3138). Furthermore, the synthesis and the structure-taste properties of novel sulfurous meat aromas is discussed (H. Bertram, R. Emberger, M. Güntert, H. Sommer, P. Werkhoff, Recent Developments in Flavor and Fragrance Chemistry, 1992, Synthesis of new flavor constituents, p. 241-259).

In the field of material research, the mathematical methods COSMO and COSMO-RS (conductor-like screening model for real solvents) are used. The semi-empirical determination model for the method according to the invention has been publicized (J. Chem. Soc. Perkin Trans. 2 (1993) 799, J. Phys. Chem. 99 (1995), 2224, J. Phys. Chem. 102 (1998) 5074 and “COSMO and COSMO-RS” in “Encyclopedia of Computational Chemistry” Wiley Verlag New York (1998) and Fluid Phase Equilibria 172 (2000) 43).

The calculation method has been developed for calculating partition coefficients of organic molecules in ideal and real solvents which are present in a static partition equilibrium.

COSMO-RS has been used for calculating physicochemical constants such as the boiling point, the vapor pressure or the partition equilibrium for octanol/water (logK_{ow}), hexane/water, benzene/water and diethyl ether/water (J. Phys. Chem. 102 (1998) 5074) and for calculating general liquid-liquid and liquid-vapor equilibria in process engineering.

Because the service life of foods and of the aromatizing present therein is continually becoming shorter, an ever more rapid new development of aromatizations is necessary. The need for detailed investigations relating to the partition parameters of aroma substances thus increases as a function of the formulations of foods. Because of the large and still growing number of these investigations, it has for years been useful and desirable to develop a process for shortening these investigations. For this purpose, effective and reliable methods are necessary for predicting partition parameters of the aroma substances between different phases. These methods should permit the preparation of aroma compositions which ensure optimized release of the individual aroma substances at the desired point in time of application of the aromatized food.

### SUMMARY OF THE INVENTION

We have found a method of selecting an aroma substance or two or more aroma substances for an aromatized product, which is characterized in that

in a first step for one group of aroma substances, a parameter is determined from the relative concentration of an aroma in the phase to be aromatized relative to the concentration in the aromatized phase,

in a second step, the descriptors of aroma substances are determined using a mathematical method,

in a third step, the parameters determined in the first step are input into a determination model and a regression calculation is carried out,

in a fourth step, a prediction is made for all calculated aroma substances based on the regression calculation,

in a fifth step, the aroma substances most effective according to the prediction are used in the aromatized preparation.

### DETAILED DESCRIPTION OF THE INVENTION

According to the method of the present invention, aroma substances are selected with a desired distribution between the aromatized phase and the phase to be aromatized, thus, for example, the optimum release of aroma substances from the aromatized food or from an aromatized substrate into the headspace to be aromatized. This produces an improved scent impression before consumption and an improved taste impression during and after consumption of the food. Furthermore, a more intensive and longer-lasting taste impression arises, which can be perceived sensorily by the consumer.

At the same time, it is possible to minimize the amount of aromatizing as a function of the scent strength and taste strength to be achieved.

Surprisingly, using the mathematical determination models and the method according to the present invention, it is possible to calculate the relative headspace concentrations and the partition parameters of aroma substances between an aromatized phase and a phase to be aromatized in dynamic and no longer only static systems comprising complex and nonuniformly structured phases, such as, for example, foods, and to predict them with outstanding accuracy. This means that although foods often consist of, for example, two or more nonideal phases and emulsions and although the determination models have been developed for calculating the static partition behavior of organic substances between two uniform solvents, it is surprisingly possible to make very good predictions for the partition behavior of aroma substances in foods.

For the purposes of the invention, aromatized phases are gaseous, liquid, solid and semisolid products which are to attain a pleasant odor or taste as a result of the addition of aroma substances or aroma compositions, or in which an unpleasant odor or taste is to be masked. The aroma substances are transferred from these aromatized phases into the phase to be aromatized.

Furthermore, for the purposes of the present invention, aromatized products are, in principle, to be understood as meaning all natural or synthetic products which are changed as a result of the addition of aroma substances (aromatizing). The products to be aromatized can be liquid or solid, but also semisolid (e.g. wax- or gel-like).

Preferred aromatized products are, for example, packaging products or foods, and application forms thereof for use as food stuffs for human or animal consumption.

More preferred aromatized products are, for example, confectionery, bakery goods, chocolates, gelatin goods, sweets, alcoholic beverages, non-alcoholic beverages, ice-cream, yogurt, milk drinks, soups, sauces, snacks, chewing-gum, mouthwashes, meat and sausage goods, vegetable protein goods, fish, cheese and baby food.

For the purposes of the present invention, phases to be aromatized are gaseous, liquid, solid and semisolid substrates which are to attain a pleasant taste as a result of the transfer of the aromatizing from the aromatized phase, or in which an unpleasant taste is to be masked.

Preferred substrates which are of importance for everyday use by people are the headspace to be aromatized, liquid phases to be aromatized, such as, for example, aqueous solutions, and also solid surfaces to be aromatized, such as, for example, the oral cavity and packaging.

Examples of aroma substances which can be added to the products to be aromatized are given, for example, in S. Arctander, Aromatize and Flavor Materials, Vol. I and II, Montclair, N.J., 1969, published privately or K. Bauer, D. Garbe and H. Surburg, Common Aroma substance and Flavor Materials, 3rd Ed., Wiley-VCH, Weinheim 1997.

Individual examples which may be mentioned are:

aroma substances from complex natural raw materials, such as extracts and essential oils obtained from plants, or fractions and uniform substances obtained therefrom, and also uniform synthetically or biotechnologically obtained compounds.

Examples of Natural Raw Materials are:

peppermint oils, spearmint oils, mentha arvensis oils, aniseed oils, clove oils, citrus oils, cinnamon bark oils, wintergreen oils, cassia oils, davana oils, fir-needle oils, eucalyptus oils, fennel oils, galbanum oils, ginger oils, camomile oils, cumin oils, rose oils, geranium oils, sage oils, yarrow oils, star anise oil, thyme oils, juniper berry oils, rosemary oils, angelica root oils, and the fractions of these oils.

Examples of Uniform Aroma Substances are:

anethole, menthol, menthone, isomenthone, methyl acetate, menthofuran, mint lactone, eucalyptol, limonene, cineol, eugenol, pinene, sabinene hydrate, 3-octanol, carvone, gamma-octalactone, gamma-nonalactone, germacrene D, viridiflorol, 1,3E,5Z-undecatriene, isopulegol, piperitone, 2-butanone, ethyl formate, 3-octyl acetate, isoamyl isovalerate, hexanol, hexanal, cis-3-hexenol, linalool, alpha-terpineol, cis and trans carvyl acetate, p-cymol, damascenone, damascone, rose oxide, dimethyl sulfide, fennel, acetaldehyde diethyl acetal, cis-4-heptenal, isobutyraldehyde, isovaleraldehyde, cis-jasmone, anisaldehyde, methyl salicylate, myrtenyl acetate, 2-phenylethyl alcohol, 2-phenylethyl isobutyrate, 2-phenylethyl isovalerate, cinnamaldehyde, geraniol, nerol. In the case of chiral compounds, the aroma substances may be present as a racemate or as individual enantiomer or as enantiomer-enriched mixture.

In the method according to the present invention, in a first step, a parameter (partition equilibrium) is determined as a quotient from the relative concentration of the aroma substance in the phase to be aromatized and the aromatized phase. Both the phase to be aromatized and the aromatized phase may be gaseous, liquid, solid or semisolid. Preferably, the phase to be aromatized is the headspace, a liquid phase above the aromatized phase or a solid substrate.

It is preferred to determine the partition equilibrium between a gas phase and a solid phase.

Alternatively, it is preferred to determine the partition equilibrium between a gas phase and a liquid phase.

This distribution depends individually on the formulation of the food and the respective application step and also on the specific molecular properties of the aroma substances. This product-specific parameter is the consequence of the specific interactions of the product or ingredients thereof with the individual aroma substances.

To determine the parameter, both the aromatized product, including all components such as the product to be aromatized itself, all aroma substances and all auxiliaries, and also simplified model products are taken into consideration.

Depending on the type of product, measurements of the aroma substances are made in the headspace above the aromatized product, in the individual application stages of the aromatized product e.g. measurements in and above solutions, and on and above various aromatized substrates, for example directly from the oral cavity. For example, for an aromatized tea, the relative concentration of the aroma substances is measured analytically above and in the tea itself, above and in a suitable aqueous solution, in and on the oral cavity.

For carrying out a regression calculation in the third step of the method according to the present invention, it is advantageous if 2 to 200 aroma substances are present as a group in the product to be investigated. It is preferred, if approximately 10 to 100, and more preferred if 20 to 50, individual aroma substances are present in the aromatized product to be investigated. This group of aroma substances, which should be structurally different, is representative of the totality of all aroma substances used for the aromatizing of a certain food. This group of aroma substances is incorporated into the product in a concentration customary for the type of product.

The relative concentration of the individual aroma substances is determined in a manner known per se by analytical methods, such as gas chromatography (GC), high performance liquid chromatography (HPLC), infrared spectrometry (IR), nuclear magnetic resonance spectrometry (NMR), mass spectrometry (MS) and ultraviolet spectrometry (UV). Furthermore, it is also possible to use signals of so-called electronic noses (D. Pybus, C. Sell, The Chemistry of Aroma substances, p. 227-232). Gas chromatography has proven particularly suitable for the analysis of aroma substances. In gas chromatography, it is also possible to use various injection methods, such as, for example, thermodesorption, liquid injection and gas injection.

Prior to analytical measurement of aroma substances, various enrichment processes can be carried out, such as, for example, extraction, concentration or adsorption. Suitable extractants or liquid-liquid or liquid-solid extractions are, for example, solvents, such as, for example, carbon dioxide, ethers, ketones, hydrocarbons, alcohols, water and esters.

Furthermore, by freezing out a static or dynamic headspace above the aromatized product or substrates treated with the aromatized product, by means of cold traps, it is possible to achieve enrichment or concentration.

Suitable for the adsorption or extraction of aroma substances from a static or dynamic headspace are surface-active adsorbents, such as, for example, plastics, Tenax®, Poropax® and activated carbon. The aroma substances enriched on these adsorbents are then desorbed using heat (thermodesorption) or solvents and can then be analyzed.

Alternatively, it is possible to measure the aroma substances analytically directly from the mouth by means of the above-described process.

In the second step, the descriptors of aroma substances are determined using a mathematical method. The descriptors describe properties such as, for example, the molecular weight, the molecular volume and the polarity.

In the first substep, conformers of the three-dimensional chemical structure of aroma substances to be calculated are generated using programmes such as, for example, Hiphop (Molecular Simulation Inc., USA) and HyperChem (Hypercube, Florida, USA). (http://nhse.npac.syr.edu:8015/rib/repositories/csir/catalog/index.html).

A field of force optimization of the structures is then carried out using calculating programmes such as, for example, Discover (Insight, Molecular Simulation Inc., USA), Merck Molecular Force Field (MMFF, Merck) or Open Force Field (OFF, MSI, USA). (http://nhse.npac.syr.edu:8015/rib/repositories/csir/catalog/index.html).

Subsequently, using accumulation analysis by means of cluster programs such as, for example, NMRClust (Oxford Molecular Ltd, UK), those conformers are selected from the resulting molecular structures which have the greatest possible structural diversity. (http://nhse.npac.syr.edu:8015/rib/repositories/csir/catalog/index.html). In particular, conformers with a low overall energy are preferred.

Subsequent structure optimization of the selected conformers is carried out using semiempirical calculation methods such as PM3 or AM1 (AMPAC, SemiChem or MOPAC, Fujitsu Ltd). (http://nhse.npac.syr.edu:8015/rib/repositories/csir/catalog/index.html).

In a further accumulation analysis, the conformers are again selected for the further calculation. (http://nhse.npac.syr.edu:8015/rib/repositories/csir/catalog/index.html).

Subsequently, a structure optimization and energy minimization is carried out using ab initio processes such as, for example, Hartree-Fock or Møller-Plesset or density functional methods (DFT) such as, for example, RI-DFT (Turbomol, Chem. Phys. Letters 162 (1989) 165) or GAUSSIAN98 (Gaussian Inc.) or DMol3 (Molecular Simulations Inc.) using the COSMO option. (http://nhse.npac.syr.edu:8015/rib/repositories/csir/catalog/index.html).

A DFT/COSMO calculation gives, as a result, the total energy of the electrostatically ideally shielded molecule and the resulting shield charge density σ on the surface of the molecule.

In the subsequent step, COSMO-RS (COSMOlogic, Germany) is used to consider the interactions of molecules in liquid systems and amorphous solids as contact interactions of ideally shielded molecules (Fluid Phase Equilibria 172 (2000) 43).

In COSMO-RS calculations, the surface shield charge densities σ on the surface of a molecule of a substance X which are relevant for the interactions are in this case reduced to a frequency distribution p^{X}(σ), which gives the composition of the sections of surface with regard to σ and is abbreviated below to σ-profile.

Subsequently, the direct or the indirect calculation of the partition parameters can be carried out using two different methods. While for the direct calculation according to the known method (Fluid Phase Equilibria 172 (2000) 43), it is necessary to know the chemical composition of both phases (of the product and of the substrate), for the indirect calculation using the novel method, no information with regard to the chemical composition is necessary.

If the chemical composition of the two phases, such as, for example, in the case of soya bean oil and air, is known, it is possible to calculate the chemical potential of any compound in the phases directly using statistical thermodynamics. The logarithmic partition parameters then arise from the difference in the chemical potentials of the aroma in the various phases.

In the rarest cases, the chemical and physical structure of the aromatized foods is uniform and known to a degree such that it is possible to use the above-described method. In this case, a novel procedure is used in which the assumption is made that, as is the case for simple liquids, it is also possible to express the affinity for solvate molecules of very different polarity by a σ-potential μ_{S}(σ) for complex phases S, as are generally present in the case of foods to be aromatized with aroma substances, if said potential can no longer be calculated directly using COSMO-RS. The shape of this function moves within the scope of the band width of σ-potentials of organic liquids. For the calculation according to the invention, μS(σ) is therefore expanded as a generalized Taylor series:

$${μ}_{S} ( σ ) ≅ {\sum }_{i = - 2}^{m} {c}_{S}^{i} {f}_{i} ( σ ) \qquad ( 1 )$$

where

fᵢ(σ)=σⁱ for i≧0 (2)

and

$${f}_{- 2 / - 1} ( σ ) = {f}_{acc / don} ( σ ) ≅ \{ \begin{matrix}0 & if \pm σ < {σ}_{hb} \\ ∓ σ + {σ}_{hb} & if \pm σ > {σ}_{hb}\end{matrix} \qquad ( 3 )$$

(Explanation of the symbols: μ_{S}(σ): σ-potential of the phase; i: index for counting the members of the series; m: highest order of the members of the series; fᵢ(σ): base function; acc: hydrogen bridge acceptor; c_{S}ⁱ: expansion coefficient of the Taylor series; don: hydrogen bridge donor; σ_{hb}: threshold for hydrogen bridge bonds)

In the case of applications with equations, seven base functions suffice, i.e. the two hydrogen bridge functions f_{acc} (acceptor behavior), f_{don} (donor behavior) and the five polynomials Mᵢ^{X} of the order m=0 to m=4, in order to accommodate any σ-potentials for aroma substances sufficiently accurately by regression. The chemical potential of a substance X in this phase S can then be written as:

$$\begin{matrix}{μ}_{S}^{X} = \int {p}^{X} ( σ ) {μ}_{S} ( σ ) ⅆ σ ≅ \int {p}^{X} ( σ ) {\sum }_{i = - 2}^{m} {c}_{S}^{i} {f}_{i} ( σ ) ⅆ σ \\ ≅ {\sum }_{i = - 2}^{m} {c}_{S}^{i} {M}_{i}^{X}\end{matrix} \qquad ( 4 )$$

where the σ-moments Mᵢ^{X} of the solvate are defined as

Mᵢ^{X}=∫p^{X}(σ)fᵢ(σ)dσ (5)

Using the seven σ-moments (f_{acc}, f_{don}, M₀^{X}, M₁^{X}, M₂^{X}, M₃^{X}, M₄^{X}) and μ_{gas}^{X}, a very generally valid principle of molecule descriptors has been found which makes it possible, according to equation (4), to determine any chemical potentials of aroma substances in very different matrices by linear regression. The phase S is characterized here by the coefficient cᵢ^{S} in front of the moments Mᵢ^{X}. In the case of charge-neutral substances, the first moment M₁^{X} is missing as a descriptor since it describes the overall charge and assumes the numerical value zero. In the case of equilibria which involve the gas phase, the chemical potential μ_{gas}^{X} of the molecule in the gas phase is to be taken into consideration as descriptor in addition to the σ-moments. This is calculated directly by the COSMOtherm software.

In the third step of the method according to the invention, the parameters determined in the first step and the descriptors obtained in the second step, alone or in combination with already known descriptors, are input into the function equation of the mathematical determination model, and a regression calculation is carried out.

For this purpose, the measured relative concentrations of the individual aroma substances in the aromatized phase and the phase to be aromatized are compared. The partition parameter obtained for each individual aroma substance is converted to the logarithm and used as so-called activity (Y) for a regression in a calculation table against the descriptors (X), and a regression calculation is carried out in a manner known per se (Böhm, Klebe, Kubinyi, Wirkstoffdesign [Active Ingredient Design], p. 370-372).

The above described σ-moment and μ_{gas}^{X} can be used, alone or in combination with already known descriptors, such as, for example, logP, both for the regression of partition parameters P^{X}_{gas,S} for substances X between the headspace to be aromatized and the aromatized phase S, and also for the regression of partition parameters P^{X}_{S,S′} for substances X between an aromatized phase S, e.g. an aqueous washing solution, and a phase S′ to be aromatized, e.g. the oral cavity.

For the distribution of substances between the headspace to be aromatized and the aromatized phase, if the setting approaches equilibrium, the logarithmic partition parameter P^{X}_{gas,S} is expressed as chemical potential difference in the determination model (6) below:

$$\begin{matrix}log {P}_{gas , S}^{X} = {c}_{gen} ( {μ}_{gas}^{X} - {μ}_{S}^{X} ) + const . \\ = {c}_{gen} {μ}_{gas}^{X} + {c}_{S}^{0} {M}_{0}^{X} + {c}_{S}^{2} {M}_{2}^{X} + {c}_{S}^{3} {M}_{3}^{X} + {c}_{S}^{4} {M}_{4}^{X} + \\ {c}_{S}^{acc} {M}_{acc}^{X} + {c}_{S}^{don} {M}_{don}^{X} + const .\end{matrix} \qquad ( 6 )$$

In the determination model (6), μ_{gas}^{X} is the chemical potential of the aroma in the gas phase calculated directly using COSMO-RS. The coefficients c_{S}ⁱ characterize the liquid or solid phase S with regard to their physical mode of interaction, while the general coefficient c_{gen} and the constant const. link together the system of units for free energies and logarithmic partition parameters. μ_{gas}^{X} and the above defined moments Mᵢ^{X} are known from the COSMO-RS calculations.

Then, if the partition parameters for a group of two to 200 different aroma substances are known by analytical measurement, and the above-described COSMO-RS calculations are available, the missing coefficients for the descriptors are uniquely determined by linear regression.

For the partition parameter P^{X}_{S,S′}, which describes the distribution between a liquid or solid phase on the one hand and between a liquid or solid phase on the other hand, the gas phase potential μ_{gas}^{X} is insignificant. This then gives, analogous to equation (6):

$$\begin{matrix}log {P}_{S , {S}^{′}}^{X} = {c}_{gen} ( {μ}_{S}^{X} - {μ}_{{S}^{′}}^{X} ) + const . \\ = {c}_{S , {S}^{′}}^{0} {M}_{0}^{X} + {c}_{S , {S}^{′}}^{2} {M}_{2}^{X} + {c}_{S , {S}^{′}}^{3} {M}_{3}^{X} + {c}_{S , {S}^{′}}^{4} {M}_{4}^{X} + \\ {c}_{S , {S}^{′}}^{acc} {M}_{acc}^{X} + {c}_{S , {S}^{′}}^{don} {M}_{don}^{X} + const .\end{matrix} \qquad ( 7 )$$

Analogous to the partition parameter P^{X}_{gas,S}, reliable regressions with regard to the partition parameter P^{X}_{S,S′} are established by linear regression for any aroma substances for which the corresponding COSMO-RS calculations have been carried out.

Various regression methods, e.g. multiple linear regression, stepwise and GFA (genetic function algorithm), are used to ascertain equations which describe the mathematical relationship between the logarithmic partition parameters of the aroma substances and the descriptors. These equations are validated using various statistical methods, such as, for example, the correlation coefficient, standard deviation, chance test, number of degrees of freedom, number of outliers, boot strap error, cross validation, lack of fit (according to Jerome Friedman), determination of the deviations, F statistics, and other methods.

The quality of the mathematical relationship is better the closer the numerical values for the correlation coefficients r² and the cross validation XVr² come to the value 1, or the higher the numerical value for the F statistics (F test) and the lower the numerical values for the standard deviation s, outliers and lack of fit.

For the use of predictions for partition parameters of aroma substances, it is generally valid that the correlation coefficient r²should be greater than 0.75 for a satisfactory correlation, greater than 0.85 for a good correlation and greater than 0.90 for a very good correlation. In order that a regression can be used for the prediction, the cross validation XVr² should be greater than 0.65 and preferably greater than 0.75 and not be more than 0.1 less than the associated correlation coefficient r².

The equation with the best correlation and best validation is used in order to calculate, beforehand, the logarithmic partition parameters in the determination model for all other aroma substances.

As a result of the regression calculation, in the fourth step of the method according to the present invention, exact predictions for the aroma substances under consideration with regard to the partition parameters between the aromatized phase and the phase to be aromatized are obtained as a result of inserting into equations (6) and (7) for all aroma substances, as a function of the coefficients and the descriptors. These prediction of the partition coefficients of the individual aroma substances are made available to flavorists in data banks.

From this grading or prediction, in a fifth step, the flavorer selects individual or two or more aroma substances which, based on the partition parameters, are particularly suitable for an aromatizing of a product. Preference is given to aroma substances with the highest possible partition parameter. These aroma substances are then used with other aroma substances in the creative composition. The aromatizing obtained in this way is then added to the product in order to satisfy the expectations of the consumers of the product with regard to its odor and taste properties.

Using these aroma substances selected in this way, it is possible to create an aromatization with a good scent and taste impression in one or more application stages for a food.

The advantage of the method according to the present invention lies in the universal and simple applicability of the calculation method for all partition parameters of aroma substances in any phases. The phases can have any desired composition which does not have to be known. The parameterization of the phases takes place via the coefficients of the descriptors in the regression equations. All descriptors are derived merely by calculation from the chemical structure of the aroma substances and do not require experimental work. Surprisingly, as a result of the method according to the present invention, an accurate and reliable mathematical description or explanation of the experimental partition parameters of aroma substances is possible. The accuracy and reliability compared with known methods and processes is, thus, considerably improved. This means that by using the novel method, in contrast to existing methods, the first reliable prediction of partition parameters for aroma substances is possible.

Hitherto, the mathematical description of the release of aroma substances from foods using predictive methods has been possible only by using experimental physicochemical measured values. In this connection, the release of the aroma substances in the mouth during consumption of foods was regarded as a priority. These methods require high experimental expenditure and are unable to describe the distribution behavior of aroma substances universally for any foods of unknown and inhomogeneous composition.

The use of known descriptors, such as the boiling point (b.p.) and the octanol-water partition coefficient (clogP, logK_{ow}) to explain the experimental data and to predict further experimental data does not lead to results which can be used for the composite work since these descriptors correlate only very poorly with the experimental values. Moreover, these mathematical models are very questionable due to the partial lack of connection with regard to the contents and produce unsuitable predictions for further experimental measurements. These predictions are too inaccurate and cannot be used usefully for the creative composition of aromatizations.

Surprisingly, by means of the process according to the present invention, an accurate and reliable mathematical description or explanation of the experimental partition parameters of aroma substances is possible by means of descriptors calculated from the chemical structure in all application steps. This considerably increases the accuracy, reliability and applicability compared with known methods and processes.

This means that by using the mathematical process for the purposes of the present invention, it is possible to carry out a reliable prediction of the relative headspace concentrations and the partition parameters of aroma substances in various phases before, during and after use of aromatized products.

As a result, laborious experimental investigations into the partition parameters of aroma substances as a function of the formulation of a food can be replaced by rapid, effective and reliable predictions.

These predictions can be used to prepare particularly effective aromatizations. These aromatizations have both a greater taste intensity and scent intensity during use of the food and also have a higher and long-lasting taste intensity following use.

The present invention also relates to products to which aroma substances have been added, which are characterized in that the aroma substances are selected for the aromatized products using a mathematical method. This method gives predictions with regard to the relative distribution of aroma substances in the phase to be aromatized relative to the aromatized phase.

The products according to the present invention to which aroma substances have been added are markedly superior in their use to aromatized products for which the aroma substances have been selected in a manner known per se.

The present invention also relates to a selection process for the preparation of novel aroma substances, which is characterized in that mathematical determination models are used in the selection of the aroma substances to be prepared in a novel manner.

The novel aroma substances according to the present invention are markedly superior in their use to aroma substances which have been selected for the preparation in a manner known per se.

The present invention also relates to aroma substances which are characterized in that the selection for the preparation of the aroma substances is carried out using a mathematical determination model.

The novel aroma substances according to the present invention are markedly superior in their use to aroma substances which have been selected for the preparation in a manner known per se.

The present invention also relates to products to which aroma substances have been added, which are characterized in that the selection for the preparation of the aroma substances used for the aromatized products is carried out using a mathematical method.

The products to which the aroma substances according to the present invention have been added are markedly superior in their use to aromatized products for which the aroma substances have been selected for the preparation in a manner known per se.

The advantage of the method according to the present invention lies in the universal and simple applicability of the calculation method for all partition parameters of aroma substances in any phases. The phases can have any desired composition, which does not have to be known. The parameterization of these phases takes place via the coefficients of the descriptors in the regression equations. All descriptors are derived merely by calculation from the chemical structure of the aroma substances and do not require experimental work.

### EXAMPLES

In general, the analytical measurement of the relative concentration of aroma substances in an aromatized product, in the headspace above the aromatized product and on the aromatized substrate are carried out, by way of example, for a group of aroma substances.

The aroma substances in the headspace can be enriched using the various methods described above, and their concentrations can be measured. The enrichment method used in each case and the analytical measurement method are matched individually to the product to be measured and to the application step in each case.

The amounts of the aroma substances found in the headspace are compared with the amount found in the aromatized product (relative partition parameters). These values are converted to the logarithm and entered as activity values into the regression table (Table 1). Using various methods, regression against the COSMO-RS and other descriptors (e.g. clogP and boiling point) are carried out, and the best correlation according to the validation is selected. In all of the regression equations belonging to the examples, aroma substances with a deviation in the regression of more than +/−0.5 log units from the experimental value are defined as outliers. The COSMO-RS regression equations obtained in this way are significantly better compared with the clogP or b.p. regression equations with regard to the quality of correlation, quality of prediction and the number of outliers. In the next step, the COSMO-RS regression equation is linked to the regression table which contains all descriptors for all aroma substances. The use of the COSMO-RS regression equation on all aroma substances gives the prediction for the logarithmic relative partition parameters for all aroma substances. These values are then used for the creation of aromas. The procedure is analogous in all examples.

The following chemical structure names are abbreviated: dimethylbenzylcarbinyl acetate (DMBCA), phenylethyl alcohol (PEA).

TABLE 1
Example of a regression table

| Substance | Activity | M₀^{x} | M₂^{x} | M₃^{x} | M₄^{x} | f_{acc} | f_{don} | G_{cosmo} |
|---|---|---|---|---|---|---|---|---|
| Alpha-Pinene | | 182.94 | 15.547 | 2.0076 | 3.7672 | 0.0036 | 0 | −9.6842 |
| Amylcinnamaldehyde, α | | 270.30 | 60.582 | 22.1066 | 50.8991 | 1.4412 | 0 | −18.6148 |
| Benzyl acetate | | 197.88 | 72.379 | 27.692 | 64.7824 | 1.7606 | 0 | −16.4831 |
| Benzyl alcohol | | 150.59 | 65.602 | 6.9788 | 87.1685 | 2.333 | 1.6507 | −13.5795 |
| Benzyl salicylate | | 259.62 | 71.418 | 1.7256 | 47.1376 | 0.2492 | 0.4879 | −18.9653 |
| Beta-Pinene | | 182.17 | 20.697 | 4.8988 | 7.2647 | 0.0087 | 0 | −10.232 |
| Camphene | | 179.45 | 19.913 | 4.4876 | 6.7674 | 0.0047 | 0 | −9.9874 |
| Caryophyllene | | 243.68 | 28.201 | 7.8143 | 11.5264 | 0.0747 | 0 | −14.1671 |
| Cedrol | | 253.34 | 47.908 | 15.6906 | 67.7804 | 2.3408 | 0.9288 | −16.476 |
| Cedryl acetate | | 279.10 | 50.828 | 28.4332 | 49.6005 | 1.7361 | 0 | −18.2928 |
| Citronellol | | 231.11 | 63.522 | 20.7436 | 94.9695 | 3.0534 | 1.5743 | −14.7972 |
| Coumarin | | 172.45 | 72.970 | 28.5131 | 82.5776 | 2.6523 | 0.001 | −18.9259 |
| Diethyl phthalate | | 250.88 | 88.235 | 40.9015 | 85.8762 | 2.0929 | 0 | −21.2179 |
| Dihydromyrcenol | | 227.10 | 56.430 | 24.3864 | 77.4421 | 2.8952 | 0.8139 | −14.0568 |
| DMBCA | | 235.19 | 64.333 | 26.0883 | 54.0729 | 1.5488 | 0 | −16.8222 |
| Ethylene brassylate | | 304.37 | 87.814 | 53.3295 | 94.7374 | 2.9648 | 0 | −24.9282 |
| Eugenol | | 211.09 | 71.061 | −2.7739 | 66.1703 | 0.4371 | 1.6307 | −16.2769 |
| gamma-Terpinene | | 196.66 | 24.722 | 6.1281 | 8.5462 | 0.0003 | 0 | −10.8848 |
| Geraniol | | 224.03 | 67.407 | 18.0173 | 96.9246 | 2.8774 | 1.7682 | −14.723 |
| Herbaflorat | | 224.20 | 59.936 | 33.5482 | 59.0415 | 1.7613 | 0 | −16.8667 |
| Hexylzimtaldehyde, α | | 286.74 | 62.029 | 23.913 | 51.3968 | 1.4679 | 0 | −19.5153 |
| Hydroxycitronellal | | 236.05 | 84.431 | 42.7048 | 121.5161 | 4.2171 | 1.1583 | −18.562 |
| Ionone, alpha | | 241.87 | 61.073 | 39.4863 | 70.3229 | 2.7962 | 0 | −18.1457 |
| Ionone, beta | | 244.28 | 57.905 | 39.5098 | 70.4258 | 3.0875 | 0 | −17.9204 |
| Iraldein, alpha | | 255.33 | 59.723 | 39.1916 | 68.4779 | 2.7242 | 0.0002 | −18.4167 |
| Isoamyl salicylate | | 255.85 | 62.035 | 12.2572 | 50.2951 | 0.6037 | 0.4704 | −16.697 |
| Isobornyl acetate | | 229.61 | 48.627 | 28.0637 | 49.6246 | 1.7189 | 0 | −15.726 |
| Lilial | | 261.24 | 63.727 | 24.457 | 48.0025 | 1.1775 | 0 | −19.1351 |
| Limonene D | | 196.12 | 27.540 | 8.2705 | 11.4017 | 0.0038 | 0 | −11.0721 |
| Linalool | | 221.83 | 59.129 | 20.8859 | 73.0534 | 2.4332 | 0.8688 | −13.7079 |
| Musk, ketone | | 288.19 | 84.911 | 22.3561 | 57.4895 | 0.6485 | 0 | −22.6713 |
| Musk, xylene | | 277.43 | 73.141 | 6.7028 | 35.7804 | 0 | 0 | −20.0232 |
| Oryclon | | 246.51 | 56.372 | 34.1065 | 58.5465 | 1.9711 | 0 | −16.6605 |
| Oryclon P 2 | | 243.70 | 52.932 | 32.4378 | 56.1438 | 2.0197 | 0 | −16.3314 |
| PEA | | 213.15 | 69.314 | 25.8393 | 56.9434 | 1.4132 | 0 | −16.4073 |
| Prenyl acetate | | 185.88 | 61.027 | 32.3413 | 61.077 | 1.8481 | 0 | −13.397 |
| Styrolyl acetate | | 211.06 | 66.887 | 26.2008 | 57.3712 | 1.5349 | 0 | −16.5608 |
| Terpineol | | 202.44 | 55.166 | 23.6513 | 79.1806 | 2.8931 | 0.9208 | −14.2052 |
| Terpinyl acetate | | 240.27 | 56.937 | 30.6541 | 53.5328 | 1.6327 | 0 | −16.2886 |

### Application Examples

### Example 1

### Milkshake, Headspace Above the Milkshake

Example formulations of aromatized milkshakes are as follows:

TABLE 2
Aromatized milk drink (1)

| Ingredients | % (w/w) |
|---|---|
| Milk, full fat | 89.75 |
| Saccharose | 7.00 |
| Oligofructose (1) | 3.00 |
| Sodium chloride | 0.10 |
| Carrageenan (2) | 0.05 |
| Flavour (3) | 0.10 |

TABLE 3
Aromatized buttermilk fruit juice drink (2)

| Ingredients | % (w/w) |
|---|---|
| Drinking water | 55.50 |
| Buttermilk | 30.00 |
| Invert sugar | 6.00 |
| Conc. fruit juice | 5.00 |
| Saccharose | 2.50 |
| Pectin | 0.50 |
| Citric acid | 0.25 |
| Sodium chloride | 0.10 |
| Flavour | 0.10 |
| Vitamin mixture | 0.05 |

Suppliers:

(1) Sensus, 4700 BH Roosendaal, NL

(2) SKW Biosystems GmbH, D-40472 Düsseldorf, Germany

(3) Haarmann & Reimer, D-37603 Holzminden, Germany

(4) Herbstreith & Fox

(5) Jungbunzlauer, D-68625 Ladenburg, Germany

(6) Nutrilo, Gesellschaft für Lebensmitteltechnologie, mbH, D-27454 Cuxhaven, Germany

The example reflects the taste impression which is perceived via the olfactory epithelium, when enjoying a milkshake. The milkshake is prepared as is generally customary. The mixture of 39 aroma substances is incorporated into the abovementioned milk product (1) in an amount of 0.2%. 50 g of this mixture are transferred to a 100 ml Erlenmeyer flask sealed with a septum and left to stand for 2 h at 35° C. with gentle stirring. The headspace above the mixture is extracted over 15 min using solid phase microextraction (SPME). The SPME needle is desorbed in a GC injector, and a gas chromatogram is recorded. The amounts of aroma substances found in the headspace are compared with the amount found in the milkshake (relative partition parameters). The analytical results are then used mathematically as described above.

A correlation in accordance with the prior art leads to the results validated below:

Correlation with clogP as descriptor: r²=0.001, F Test=0.02, XVr²=−0.13, outliers: 27 of 37 substances.

Correlation with b.p. as descriptor: r²=0.60, F Test=57.5, XVr²=0.56, outliers: 16 of 37 substances.

Correlation with b.p. and clogP as descriptors: r²=0.65, F Test=33.8, XVr²=0.57, outliers: 17 of 37 substances.

COSMO-RS correlation: r²=0.86, F Test=26.9, XVr²=0.71, with descriptors: M₂^{X}, M₃^{X}, M₄^{X}, f_{acc}, f_{don}, ΔG_{Cosmo}, outliers: 11 of 37 substances.

TABLE 4
Example logarithmic partition parameters above a milkshake
according to COSMO-RS correlation.

| Substance | Activity | Prediction | Differences |
|---|---|---|---|
| alpha-Pinene | 1.078 | 1.011 | 0.067 |
| Amylcinnamaldehyde, α | −1.375 | −1.175 | −0.199 |
| Benzyl acetate | 0.306 | −0.209 | 0.515 |
| Benzyl alcohol | −0.819 | −0.428 | −0.391 |
| Benzyl salicylate | −3.313 | −2.256 | −1.057 |
| Beta-Pinene | 1.029 | 1.111 | −0.082 |
| Camphene | 0.985 | 1.154 | −0.169 |
| Caryophyllene | 1.132 | 0.039 | 1.094 |
| Cedrol | −1.077 | −1.053 | −0.025 |
| Cedryl acetate | −1.690 | −0.575 | −1.114 |
| Citronellol | 0.199 | 0.060 | 0.138 |
| Coumarin | −1.731 | −1.975 | 0.244 |
| Diethyl phthalate | −1.607 | −1.054 | −0.553 |
| Dihydromyrcenol | 0.432 | 0.297 | 0.135 |
| DMBCA | 0.378 | −0.159 | 0.537 |
| Eugenol | −0.557 | −1.085 | 0.528 |
| gamma-Terpinene | 1.064 | 1.068 | −0.004 |
| Geraniol | −0.053 | 0.098 | −0.151 |
| Herbaflorat | −0.025 | 0.275 | −0.300 |
| Hexylcinnamaldehyde, α | −1.949 | −1.275 | −0.674 |
| Hydroxycitronellal | −1.679 | −0.310 | −1.369 |
| Ionone, α | −0.001 | −0.159 | 0.158 |
| Ionone, β | −0.154 | −0.201 | 0.047 |
| Iraldein, α | −0.377 | −0.222 | −0.154 |
| Isoamyl salicylate | −0.528 | −0.743 | 0.215 |
| Isobornyl acetate | 0.707 | 0.227 | 0.480 |
| Lilial | −0.690 | −0.824 | 0.135 |
| Limonene D | 1.088 | 1.178 | −0.090 |
| Linalool | 0.225 | 0.456 | −0.231 |
| Musk, xylene | −2.648 | −2.146 | −0.501 |
| Oryclon P 1 | 0.641 | 0.316 | 0.325 |
| Oryclon P 2 | 0.463 | 0.264 | 0.199 |
| PEA | 0.188 | −0.036 | 0.225 |
| Prenyl acetate | 0.413 | 1.277 | −0.864 |
| Styrolyl acetate | 0.402 | −0.152 | 0.554 |
| Terpineol | 0.032 | 0.200 | −0.167 |
| Terpinyl acetate | 0.418 | 0.363 | 0.055 |

From a list with these and further aroma substances with predicted partition parameters, the flavorist selects individual or many aroma substances which are particularly suitable within the scope of the method according to the present invention for an aromatizing of milkshakes using this shampoo. Using these aroma substances, hedonically outstanding aromatizations are created which achieve a superior taste impression.

### Example 2

### Lemonade, Headspace Above the Lemonade

Example formulations of aromatized lemonades are as follows:

TABLE 5
Aromatized, carbonated refreshing drink (1)

| Ingredients | % (w/w) |
|---|---|
| Prepared drinking water | 82.10 |
| Invert sugar | 14.00 |
| Citric acid | 0.20 |
| Aromatized drink base (2) | 2.50 |
| Carbon dioxide | 1.20 |

TABLE 6
Aromatized lemonade with juice content (2)

| Ingredients | % (w/w) |
|---|---|
| Prepared drinking water | 71.20 |
| Lemonade base, 10:100 juice content | 17.20 |
| 240%, extract content 40% (2) | |
| Invert sugar | 11.60 |

Suppliers:

(1) Jungbunzlauer, D-68625 Ladenburg, Germany

(2) Haarmann & Reimer GmbH, D-37603 Holzminden, Germany

The example reflects the taste impression which is perceived from via the olfactory epithelium, when enjoying a lemonade drink. The mixture of 39 odorants is incorporated into the above-mentioned lemonade drink (1) in an amount of 0.05%. 50 g of the lemonade drink are transferred to a 100 ml Erlenmeyer flask sealed with a septum and left to stand for 2 h at 35° C. with gentle stirring. The headspace above the lemonade is extracted using a SPME over 15 min. The amounts of odorants found in the headspace are compared with the amount present in the lemonade (relative partition parameters). The analytical results are then used mathematically as described above.

Correlation with clogP: r²=0.015, F Test=0.49, XVr²=−0.15, outliers: 24 of 37 substances.

Correlation with b.p.: r²=0.51, F Test=33.1, XVr²=0.46, outliers: 18 of 37 substances.

Correlation with b.p. and clogP: r²=0.59, F Test=22.3, XVr²=0.51, with descriptors: b.p., clogP, outliers: 21 of 37 substances.

COSMO-RS correlation: r²=0.85, F Test=24.0, XVr²=0.73, with descriptors: M₂^{X}, M₃^{X}, M₄^{X}, f_{acc}, f_{don}, ΔG_{Cosmo}, outliers: 12 of 37 substances.

TABLE 7
Example logarithmic partition parameters above lemonade
according to COSMO-RS correlation

| Substance | Activity | Prediction | Differences |
|---|---|---|---|
| alpha-Pinene | 0.363 | 0.474 | −0.110 |
| Amylcinnamaldehyde, α | −1.299 | −1.206 | −0.093 |
| Benzyl acetate | 0.086 | −0.466 | 0.552 |
| Benzyl alcohol | −1.955 | −1.171 | −0.783 |
| Benzyl salicylate | −3.037 | −2.696 | −0.340 |
| beta-Pinene | 0.485 | 0.675 | −0.189 |
| Camphene | 0.465 | 0.691 | −0.226 |
| Caryophyllene | 0.827 | −0.052 | 0.879 |
| Cedrol | −0.895 | −1.091 | 0.196 |
| Cedryl acetate | −1.653 | −0.220 | −1.433 |
| Citronellol | 0.044 | −0.162 | 0.207 |
| Coumarin | −1.763 | −1.925 | 0.162 |
| Diethyl phthalate | −1.895 | −0.202 | −1.693 |
| Dihydromyrcenol | 0.334 | −0.178 | 0.513 |
| DMBCA | 0.523 | −0.374 | 0.898 |
| Eugenol | −0.841 | −1.295 | 0.454 |
| gamma-Terpinene | 1.032 | 0.621 | 0.411 |
| Geraniol | −0.413 | −0.188 | −0.225 |
| Herbaflorat | 0.092 | 0.698 | −0.605 |
| Hexylcinnamaldehyde, α | −1.911 | −1.201 | −0.710 |
| Hydroxycitronellal | −1.879 | −0.011 | −1.868 |
| Ionone, ∀ | 0.024 | 0.084 | −0.060 |
| Ionone, ∃ | −0.061 | −0.134 | 0.072 |
| Iraldein, ∀ | −0.311 | 0.091 | −0.403 |
| Isoamyl salicylate | −0.462 | −0.664 | 0.201 |
| Isobornyl acetate | 0.994 | 0.407 | 0.587 |
| Lilial | −0.656 | −0.731 | 0.074 |
| Limonene D | 0.925 | 0.852 | 0.072 |
| Linalool | 0.141 | −0.104 | 0.246 |
| Musk, xylene | −2.789 | −2.641 | −0.147 |
| Oryclon P 1 | 0.856 | 0.670 | 0.185 |
| Oryclon P 2 | 0.654 | 0.503 | 0.150 |
| PEA | 0.001 | −0.270 | 0.272 |
| Prenyl acetate | 0.151 | 1.190 | −1.038 |
| Styrolyl acetate | 0.312 | −0.329 | 0.641 |
| Terpineol | −0.257 | −0.131 | −0.126 |
| Terpinyl acetate | 0.644 | 0.583 | 0.060 |

From a list with these and other aroma substances with predicted partition parameters, the flavorist selects individual or many aroma substances which are particularly suitable within the scope of the method according to the invention for aromatizing this lemonade. Using these aroma substances, hedonically outstanding aromatizations are created which achieve a superior taste impression.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of selecting an aroma substance or two or more aroma substances for a product to be aromatized, comprising the steps of
a) determining a parameter for one group of aroma substances from the relative concentration of an aroma substance in the phase to be aromatized relative to the concentration in the aromatized phase,
b) determining the descriptors of aroma substances using a mathematical method,
c) inputting the parameters determined in step (a) into a determination model and carrying out a regression calculation,
d) making a prediction for all calculated aroma substances based on the regression calculation, and
e) using the aroma substances most effective according to the prediction are used in the composition of an aroma preparation.

2. A method according to claim 1, wherein the step of the determination of the relative distribution of aroma substances is carried out by analysis of the concentration in the aromatized phase and the phase to be aromatized.

3. A method according to claim 1, wherein a partition equilibrium between the gas phase and a liquid phase is determined.

4. A method according to claim 1, wherein a partition equilibrium between the gas phase and a solid phase is determined.

5. A method according to claim 1, wherein a partition equilibrium between a liquid phase and a solid phase is determined.

6. A method according to claim 1, wherein a partition equilibrium between two liquid phases is determined.

7. A method according to claim 1, wherein the group of aroma substances comprises 2 to 200 individual compounds.

8. A method according to claim 7, wherein the group of aroma substances comprises 10 to 100 individual compounds.

9. A method according to claim 8, wherein the group of aroma substances comprises 20 to 50 individual compounds.

10. A method according to claim 1, wherein, in the determination of the descriptors of the aroma substances using a mathematical method,
a) conformers are first generated,
b) then the field of force is optimized,
c) then the conformers are selected by accumulation analysis,
d) then a semi-empirical structure optimization is performed,
e) then further conformers are selected by accumulation analysis,
f) then the structure using ab-initio or DFT calculations is optimized, and
g) finally, a COSMO-RS calculation is carried out.

11. A method according to claim 10, wherein a dielectric continuum calculating method is used to calculate descriptors of the aroma substances.

12. A method according to claim 10, wherein a mathematical determination model for the distribution between the gas phase and a liquid or solid phase is described by the function
$$\begin{matrix}log {P}_{gas , S}^{X} = {C}_{gen} ( {μ}_{gas}^{X} - {μ}_{S}^{X} ) + const . \\ = {C}_{gen} {μ}_{gas}^{X} + {C}_{S}^{0} {M}_{0}^{X} + {C}_{S}^{2} {M}_{2}^{X} + {C}_{S}^{3} {M}_{3}^{X} + \\ {C}_{S}^{4} {M}_{4}^{X} + {C}_{S}^{acc} {M}_{acc}^{X} + {C}_{S}^{don} {M}_{don}^{X} + const .\end{matrix}$$
in which the symbols have the following meanings:
P^{X}_{gas,S}: partition parameter between gas phase and liquid or solid phase; c_{gen}: general, customized preliminary factor;
μ^{X}_{gas}: chemical potential of substance X in the gas phase according to COSMO-RS;
μ_{S}^{X}: chemical potential of substance X in the solid or liquid phase from regression;
const: general regression constant;
c_{S}ⁱ: expansion coefficient of the Taylor series from regression;
acc: hydrogen bridge acceptor;
don: hydrogen bridge donor; and
Mᵢ^{X}: σ-moment of the i-th order of the substance X.

13. A method according to claim 10, wherein a mathematical determination model for the distribution between a liquid or solid phase and a liquid or solid phase is described by the function
$$\begin{matrix}log {P}_{S , {S}^{′}}^{X} = {c}_{gen} ( {μ}_{S}^{X} - {μ}_{{S}^{′}}^{X} ) + const . \\ = {c}_{S , {S}^{′}}^{0} {M}_{0}^{X} + {c}_{S , {S}^{′}}^{2} {M}_{2}^{X} + {c}_{S , {S}^{′}}^{3} {M}_{3}^{X} + \\ {c}_{S , {S}^{′}}^{4} {M}_{4}^{X} + {c}_{S , {S}^{′}}^{acc} {M}_{acc}^{X} + {c}_{S , {S}^{′}}^{don} {M}_{don}^{X} + const .\end{matrix}$$
in which the symbols have the following meanings:
P^{X}_{S,S′}: partition parameter between liquid phase S and liquid or solid phase S′; c_{gen}: general, customized preliminary factor;
μ^{X}_{S}: chemical potential of substance X in the liquid phase S according to COSMO-RS;
μ^{X}_{S′}: chemical potential of substance X in the solid or liquid phase S′ from regression;
const: general regression constant;
c_{S}ⁱ: expansion coefficient of the Taylor series from regression;
acc: hydrogen bridge acceptor; don: hydrogen bridge donor; and
Mᵢ^{X}: σ-moment of the i-th order of the substance X.

14. A method according to claim 12, wherein a mathematical determination model is created using the σ-moments M₀^{X}, M₂^{X}, M₃^{X}, M₄^{X}, and M_{acc}^{X}, M_{don}^{X} and μ_{gas}^{X} as descriptors and a constant.

15. A method according to claim 12, wherein a mathematical determination model is created using the σ-moments M₀^{X}, M₂^{X}, M₃^{X}, M₄^{X}, and M_{acc}^{X}, M_{don}^{X} and μ_{gas}^{X} as descriptors and a constant.

16. A method according to claim 13, wherein a mathematical determination model is created using the σ-moments M₀^{X}, M₂^{X}, M₃^{X}, M₄^{X}, and M_{acc}^{X}, M_{don}^{X} and μ_{gas}^{X} as descriptors and a constant in combination with descriptors already known.

17. A method according to claim 13, wherein a mathematical determination model is created using the σ-moments M₀^{X}, M₂^{X}, M₃^{X}, M₄^{X}, and M_{acc}^{X}, M_{don}^{X} and μ_{gas}^{X} as descriptors and a constant in combination with descriptors already known.

18. A method according to claim 1, wherein a regression calculation is carried out to correlate the descriptors with the partition parameters of the aroma substances.

19. A method according to claim 1, wherein a prediction is made for the partition parameters of aroma substances.

20. A method according to claim 1, wherein the prediction of the partition parameters of aroma substances is used for the preparations of aroma compositions.

21. A method according to claim 1, wherein said product to be aromatized is a food.

22. A method according to claim 1, wherein said product to be aromatized are foods and packaging in the domestic sector.

23. A method according to claim 1, wherein said product to be aromatized are foods and packaging in the industrial sector.

24. A method according to claim 1, wherein said product to be aromatized are foods and packaging for animal use.

25. Aromatized products comprising the aroma substances which are selected for the aromatized products using a mathematical determination model where
a) in a first step for one group of aroma substances, a parameter is determined from the relative concentration of an aroma substance in the phase to be aromatized relative to the concentration in the aromatized phase,
b) in a second step, the descriptors of aroma substances are determined using a mathematical method,
c) in a third step, the parameters determined in the first step are inputted into a determination model and a regression calculation is carried out,
d) in a fourth step, a prediction is made for all calculated aroma substances based on the regression calculation,
e) in a fifth step, the aroma substances most effective according to the prediction are used in the composition of an aromatizing.

26. Aromatized products according to claim 25, wherein the aroma substance for the aromatized products are selected using a mathematical determination model which describes the distribution of aroma substances between an aromatized phase and a phase to be aromatized.

27. Aromatized products according to claim 25, wherein the aroma substances for the aromatized products are selected using a mathematical determination model in which the distribution between the gas phase and a liquid or solid phase is described by the function
$$\begin{matrix}log {P}_{gas , S}^{X} = {C}_{gen} ( {μ}_{gas}^{X} - {μ}_{S}^{X} ) + const . \\ = {C}_{gen} {μ}_{gas}^{X} + {C}_{S}^{0} {M}_{0}^{X} + {C}_{S}^{2} {M}_{2}^{X} + {C}_{S}^{3} {M}_{3}^{X} + \\ {C}_{S}^{4} {M}_{4}^{X} + {C}_{S}^{acc} {M}_{acc}^{X} + {C}_{S}^{don} {M}_{don}^{X} + const .\end{matrix}$$
in which the symbols have the following meanings:
P^{X}_{gas,S}: partition parameter between gas phase and liquid or solid phase; c_{gen}: general, customized preliminary factor;
μ^{X}_{gas}: chemical potential of substance X in the gas phase according to COSMO-RS;
μ_{S}^{X}: chemical potential of substance X in the solid or liquid phase from regression;
const: general regression constant;
c_{S}ⁱ: expansion coefficient of the Taylor series from regression;
acc: hydrogen bridge acceptor;
don: hydrogen bridge donor; and
Mᵢ^{X}: σ-moment of the i-th order of the substance X.

28. Aromatized products according to claim 25, wherein the aroma substances for the aromatized products are selected using a mathematical determination model in which the distribution between a liquid or solid phase and a liquid or solid phase is described by the function
$$\begin{matrix}log {P}_{S , {S}^{′}}^{X} = {c}_{gen} ( {μ}_{S}^{X} - {μ}_{{S}^{′}}^{X} ) + const . \\ = {c}_{S , {S}^{′}}^{0} {M}_{0}^{X} + {c}_{S , {S}^{′}}^{2} {M}_{2}^{X} + {c}_{S , {S}^{′}}^{3} {M}_{3}^{X} + \\ {c}_{S , {S}^{′}}^{4} {M}_{4}^{X} + {c}_{S , {S}^{′}}^{acc} {M}_{acc}^{X} + {c}_{S , {S}^{′}}^{don} {M}_{don}^{X} + const .\end{matrix}$$
in which the symbols have the following meanings:
P^{X}_{S,S′}: partition parameter between liquid phase S and liquid or solid phase S′; c_{gen}: general, customized preliminary factor;
μ^{X}_{S}: chemical potential of substance X in the liquid phase S according to COSMO-RS;
μ^{X}_{S′}: chemical potential of substance X in the solid or liquid phase S′ from regression;
const: general regression constant;
c_{S}ⁱ: expansion coefficient of the Taylor series from regression;
acc: hydrogen bridge acceptor;
don: hydrogen bridge donor; and
Mᵢ^{X}: σ-moment of the i-th order of the substance X.

29. Aromatized products according to claim 27, wherein the aroma substances for the aromatized products are selected by means of a mathematical determination model using the σ-moments M₀^{X}, M₂^{X}, M₃^{X}, M₄^{X}, and M_{acc}^{X}, M_{don}^{X} and μ_{gas}^{X} as descriptors and a constant.

30. Aromatized products according to claim 27, wherein the aroma substances for the aromatized products are selected by means of a mathematical determination model using the σ-moments M₀^{X}, M₂^{X}, M₃^{X}, M₄^{X}, and M_{acc}^{X}, M_{don}^{X} and μ_{gas}^{X} as descriptors and a constant in combination with descriptors already known.

31. Aromatized products according to claim 28, wherein the aroma substances for the aromatized products are selected by means of a mathematical determination model using the σ-moments M₀^{X}, M₂^{X}, M₃^{X}, M₄^{X}, and M_{acc}^{X}, M_{don}^{X} and μ_{gas}^{X} as descriptors and a constant.

32. Aromatized products according to claim 28, wherein the aroma substances for the aromatized products are selected by means of a mathematical determination model using the σ-moments M₀^{X}, M₂^{X}, M₃^{X}, M₄^{X}, and M_{acc}^{X}, M_{don}^{X} and μ_{gas}^{X} as descriptors and a constant in combination with descriptors already known.

33. Aromatized products according to claim 25, wherein the products added are foods.

34. Aromatized products according to claim 25, wherein the aromatized products are foods and packaging for industrial use.

35. Aromatized products according to claim 25, wherein the aromatized products are foods and packaging in the domestic sector.

36. Aromatized products according to claim 25, wherein the aromatized products are foods and packaging for animal use.

37. A method of selecting an aroma substance or two or more aroma substances for a preparation, comprising the steps of:
a) determining a parameter for one group of aroma substances from the relative concentration of an aroma substance in the phase to be aromatized relative to the concentration in the aromatized phase,
b) determining the descriptors of aroma substances using a mathematical method,
c) inputting the parameters determined in step (a) into a determination model and carrying out a regression calculation,
d) making a prediction for all calculated aroma substances based on the regression calculation, and
e) using the aroma substances most effective according to the prediction in the composition of an aroma.

38. A method according to claim 37, wherein the step of the determination of the relative distribution of aroma substances is carried out by analysis of the concentration in the aromatized phase and the phase to be aromatized.

39. A method according to claim 37, wherein a partition equilibrium between the gas phase and a liquid phase is determined.

40. A method according to claim 37, wherein a partition equilibrium between the gas phase and a solid phase is determined.

41. A method according to claim 37, wherein a partition equilibrium between a liquid phase and a solid phase is determined.

42. A method according to claim 37, wherein a partition equilibrium between two liquid phases is determined.

43. A method according to claim 37, wherein the group of aroma substances comprises 2 to 200 individual compounds.

44. A method according to claim 37, wherein the group of aroma substances comprises 10 to 100 individual compounds.

45. A method according to claim 44, wherein the group of aroma substances comprises 20 to 50 individual compounds.

46. A method according to claim 37, wherein, in the calculation of the descriptors of the aroma substances using a mathematical determination method,
a) conformers are first generated,
b) then the field of force is optimized,
c) then conformers are selected by accumulation analysis,
d) then a semi-empirical structure optimization takes place,
e) then further conformers are selected by accumulation analysis,
f) then the structure is optimized using ab-initio or DFT calculations, and
g) finally, a COSMO-RS calculation is carried out.

47. A method according to claim 46, wherein a dielectric continuum calculating method is used to calculated descriptors of the aroma substances.

48. A method according to claim 46, wherein in said mathematical determination model for the distribution between the gas phase and a liquid or solid phase is described by the function
$$\begin{matrix}log {P}_{gas , S}^{X} = {C}_{gen} ( {μ}_{gas}^{X} - {μ}_{S}^{X} ) + const . \\ = {C}_{gen} {μ}_{gas}^{X} + {C}_{S}^{0} {M}_{0}^{X} + {C}_{S}^{2} {M}_{2}^{X} + {C}_{S}^{3} {M}_{3}^{X} + \\ {C}_{S}^{4} {M}_{4}^{X} + {C}_{S}^{acc} {M}_{acc}^{X} + {C}_{S}^{don} {M}_{don}^{X} + const .\end{matrix}$$
in which the symbols have the following meanings:
P^{X}_{gas,S}: partition parameter between gas phase and liquid or solid phase;
c_{gen}: general, customized preliminary factor;
μ^{X}_{gas}: chemical potential of substance X in the gas phase according to COSMO-RS;
μ_{S}^{X}: chemical potential of substance X in the solid or liquid phase from regression;
const: general regression constant;
c_{S}ⁱ: expansion coefficient of the Taylor series from regression;
acc: hydrogen bridge acceptor;
don: hydrogen bridge donor;
Mᵢ^{X}: σ-moment of the i-th order of the substance X.

49. A method according to claim 46, wherein a mathematical determination model for the distribution between a liquid or solid phase and a liquid or solid phase is described by the function
$$\begin{matrix}log {P}_{S , {S}^{′}}^{X} = {c}_{gen} ( {μ}_{S}^{X} - {μ}_{{S}^{′}}^{X} ) + const . \\ = {c}_{S , {S}^{′}}^{0} {M}_{0}^{X} + {c}_{S , {S}^{′}}^{2} {M}_{2}^{X} + {c}_{S , {S}^{′}}^{3} {M}_{3}^{X} + {c}_{S , {S}^{′}}^{4} {M}_{4}^{X} + {c}_{S , {S}^{′}}^{acc} {M}_{acc}^{X} + \\ {c}_{S , {S}^{′}}^{don} {M}_{don}^{X} + const .\end{matrix}$$
in which the symbols have the following meanings:
P^{X}_{S,S′}:partition parameter between liquid phase S and liquid or solid phase S′; c_{gen}: general, customized preliminary factor;
μ^{X}_{S}: chemical potential of substance X in the liquid phase S according to COSMO-RS;
μ^{X}_{S′}: chemical potential of substance X in the solid or liquid phase S′ from regression;
const: general regression constant;
c_{S}ⁱ: expansion coefficient of the Taylor series from regression;
acc: hydrogen bridge acceptor; don: hydrogen bridge donor; and
Mᵢ^{X}: σ-moment of the i-th order of the substance X.

50. A method according to claim 48, wherein a mathematical determination model is created using the σ-moments M₀^{X}, M₂^{X}, M₃^{X}, M₄^{X}, of M_{acc}^{X}, M_{don}^{X} and μ_{gas}^{X} as descriptors and a constant.

51. A method according to claim 48, wherein a mathematical determination model is created using the σ-moments M₀^{X}, M₂^{X}, M₃^{X}, M₄^{X}, of M_{acc}^{X}, M_{don}^{X} and μ_{gas}^{X} as descriptors and a constant in combination with descriptors already known.

52. A method according to claim 49, wherein a mathematical determination model is created using the σ-moments M₀^{X}, M₂^{X}, M₃^{X}, M₄^{X}, of M_{acc}^{X}, M_{don}^{X} and μ_{gas}^{X} as descriptors and a constant.

53. A method according to claim 49, wherein a mathematical determination model is created using the a-moments σ-moments M₀^{X}, M₂^{X}, M₃^{X}, M₄^{X}, of M_{acc}^{X}, M_{don}^{X} and μ_{gas}^{X} as descriptors and a constant in combination with descriptors already known.

54. A method according to claim 37, wherein a regression calculation is carried out to correlate the descriptors with the partition parameters of the aroma substances.

55. A method according to claim 37, wherein a prediction is made for the partition parameters of aroma substances.

56. A method according to claim 37, wherein the prediction of the partition parameters of aroma substances is used for the composition of aromas and aroma mixtures.
